(19) United States
(12) Patent Application Publication
(10) Pub. No.: US 2025/0385536 A1
(43) Pub. Date: Dec. 18, 2025

(54) Interface Module for Charging and Discharging an Electrochemical Energy Store

(71) Applicant: Robert Bosch GmbH, Stuttgart (DE)

(72) Inventors: Alexander Spaeth, Gomaringen (DE); Fabian Ebert, Reutlingen (DE); Achim Seidel, Filderstadt (DE); Daniel Monteiro Teixeira, Lichtenstein (DE); Wolfgang Weydanz, Buckenhof (DE); Johannes Fischer, Reutlingen (DE)

(21) Appl. No.: 18/878,536

(22) PCT Filed: Jun. 20, 2023
(86) PCT No.: PCT/EP2023/066634

§ 371 Date: Dec. 23, 2024

(30) Foreign Application Priority Data
Jul. 11, 2022 (DE) 10 2022 207 058.5

(51) Int. Cl. H02J 7/00; B60L 50/20; B60L 50/60; B60L 53/22; B60L 53/30; B60L 55/00; H02J 50/10

(52) U.S. Cl. CPC H02J 7/00712; B60L 50/60; B60L 53/22; B60L 53/30; B60L 55/00; H02J 7/0047; B60L 50/20; B60L 2200/12; B60L 2210/10; H02J 50/10

(57) ABSTRACT

An interface module for charging and discharging an electrochemical energy store for an electrical consumer, in particular for an electric-motor-powered vehicle, includes a first interface and at least one second interface that is electrically connected to the first interface. The first interface is designed, in particular of proprietary design, such that the interface module is connectable to a corresponding counterpart of the electrochemical energy store. The at least one second interface is of universal design such that the interface module is connectable to a corresponding counterpart interface of an external constant-voltage or constant-current source for the purpose of charging the electrochemical energy store. The at least one second interface is further connectable to a corresponding counterpart interface of a further electrical consumer for the purpose of discharging the electrochemical energy store.

The invention relates to an interface module for charging and discharging an electrochemical energy store for an electrical consumer, as well as an adapter and an electric-motor-powered vehicle having an interface module according to the invention belonging to the class of patent specified in the independent claim.

### PRIOR ART

A large number of electrical consumers are operated with rechargeable electrochemical energy stores, which are discharged by the electrical consumer and can be charged using a charger. Typically, such energy stores consist of a plurality of energy store cells interconnected in series and/or parallel in order to achieve a required battery voltage or capacity. A particularly advantageous and quite high power and energy density can be achieved if the energy store cells are designed as, e.g., lithium ion cells (Li-ion).

In particular, energy stores for high power and energy densities typically need to be recharged with special chargers. For this purpose, both the chargers and the electrochemical energy stores have special high-performance connections as electromechanical interfaces, which are often manufacturer-specific—i.e., proprietary—because in addition to the energy, charging protocols and/or operating parameters, such as a battery voltage, a battery power, a temperature measured in the energy store, special coding signals, etc. are also are transmitted from the energy store to the charger to monitor the charging process. The error-free interaction of the energy store with the charger and the application is very important, as errors can cause safety-relevant issues including a fire in the energy store. This transfer can be carried out either via specific data or signal contacts of the electromechanical interfaces or also as powerline communication via the power contacts. Furthermore, the charger must have special and therefore often costly charging electronics (AC/DC converters, isolation transformers, specially designed rectifiers and power amplifiers, etc.).

With the Bosch GAA 18V-24 and GAA 12V-21, adapters for the use of electric tool exchangeable battery packs for further electrical consumers, such as smartphones, heating vests, etc. are also known. To this end, the adapters can be pushed onto the exchangeable battery packs without tools using a first, proprietary, electromechanical interface compatible with the exchangeable battery packs in order to then supply the electrical consumers with energy from the exchangeable battery packs using a second universal USB-A interface.

It is the object of the invention to provide an interface module that, in addition to discharging, also enables a safe charging of an electrochemical energy store, in particular a high-energy electrochemical store, with an external energy source which is easy to design and therefore inexpensive.

### ADVANTAGES OF THE INVENTION

In order to achieve this object, it is provided that the first interface is designed, in particular of proprietary design, such that the interface module is connectable to a corresponding counterpart of the electrochemical energy store, and that the at least one second interface is of universal design such that the interface module is connectable to a corresponding counterpart interface of an external constant-voltage or constant-current source for the purpose of charging the electrochemical energy storage and is connectable to a corresponding counterpart interface of a further electrical consumer for the purpose of discharging the electrochemical energy store.

With particular advantage, the invention enables charging of an electrochemical energy store, in particular a high-performance electrochemical energy store, with a standardized universal charger, which can be designed as a cost-effective constant-voltage or constant-current source without complex AC/DC conversion or specifically designed rectification. Examples include USB plug power supplies, power banks, or simple automotive charging adapters. In contrast to a charger that controls to a fixed battery voltage using, for example, a Constant Current Constant Voltage (CCCV) charging process, a constant voltage or current source only provides a certain maximum voltage or certain maximum current.

In addition to the charging function, the discharging function of the high-performance electrochemical energy store via the second universal interface allows it to be used as a power bank for operating one or more further electrical consumer(s), such as a laptop, for charging a cell phone, a light, an electric compressor or fan, or the like.

A proprietary interface is to be understood to mean an interface that is specific to one manufacturer or a closed group of manufacturers and therefore cannot be used universally. In contrast, a universal interface is to be understood as an interface that can be used by a variety of different manufacturers and that has established itself in particular as a manufacturer-independent standard.

The term “charging and discharging” is to be understood to mean that the interface module is suitable for both charging the electrochemical energy store—i.e., for transferring energy to energy store—and discharging the electrochemical energy store—i.e., for transferring energy from the energy store. In particular, this means that the interface module can be used to charge and discharge the electrochemical energy store connected to the interface module both simultaneously and at different times. Simultaneous charging and discharging is possible, for example, if another electrical consumer is also connected to a universal interface of the interface module in parallel with the charger.

The electrical consumer may be configured in particular as an electric-motor-powered vehicle, for example as an electric bicycle (e.g., EPAC—Electrically Power Assisted Cycle, e-bike, pedelec, e-cargo bicycle, etc.), an electric motorbike, a one-or two-wheeled e-scooter, an e-moped, or the like. The invention is also applicable to other applications in the field of micro-mobility applications such as e-kick scooters, mono-wheels, or other non type-approved vehicles with fixed or interchangeable battery packs installed in the vehicle. An electric-motor-powered vehicle is therefore also to be understood as a vehicle that comprises a drive unit to assist the driver or an electromotive partial drive.

Electrical consumers in the context of the invention can also be understood to mean battery-operated power tools for machining workpieces by means of an electrically driven insert tool. The power tools can be designed not only as a hand-held power tool, but also as a stationary machine tool. In addition, the battery pack may be fixedly integrated in the machine tool or may be designed to be replaceable without tools. Typical machine tools in this context include hand-held or stationary drills, screwdrivers, impact drills, hammer drills, planers, angular grinders, oscillating sanders, polishing machines, or the like. However, electrical consumers also include battery-powered garden and construction equipment such as lawn mowers, lawn trimmers, branch saws, motorized and trenchers, blowers, robot breakers and excavators and the like. Furthermore, the invention is applicable to battery-powered measuring devices, such as laser rangefinders or levelers, wall scanners, etc., as well as household appliances, such as vacuum cleaners, mixers and camping accessories, such as battery powered cooling or heating devices, coffee machines, etc. The invention is also applicable to electrical consumers that are simultaneously supplied with a plurality of exchangeable battery packs in order to achieve a high operating time and/or performance.

The electrical consumer may have a brushless DC motor (EC or BLDC motor) controlled by a power output stage using pulse width modulation (PWM). Other types of electric motors, such as brush-type DC motors or AC motors, as well as inductive, capacitive, and/or ohmic loads, which are supplied with energy via the electrochemical energy stores, are also conceivable without limiting the invention. These are well known to the skilled person, so they will not be further addressed herein.

The electrochemical energy store can be fixedly integrated in the electrical consumer or can be configured as a tool-free, detachable exchangeable battery pack. In the case of an exchangeable battery pack, it may also be provided that it can be charged in both the state connected to the consumer and the state separate from the consumer. Specifically, discharging by the application or use of the application may also be prevented when the exchangeable battery pack is being charged, e.g., in electrically powered/assisted vehicles. The battery voltage of a typical exchangeable energy store is usually a multiple of the voltage of a single energy store cell of the energy store and results from the interconnection (parallel and/or series) of the individual energy store cells. Preferably, the energy storage cells are designed as lithium-based energy storage cells, e.g., Li-ion, Li-polymer, Li-metal, Na-ion, or the like. However, the invention can also be applied to electrochemical energy stores having Ni—Cd cells, Ni-Mh cells, or other suitable cell types. For common Li-Ion energy storage cells with a cell voltage of 3.6 V, nominal battery voltages of 3.6 V, 18 V, 36 V, 54 V, etc. result by way of example. However, the invention does not depend on the type and design of the energy storage cells used and the energy store, but can be applied to any electrochemical energy stores and energy storage cells, e.g., in addition to round cells also pouch cells or the like, with battery voltages of 36 V, 48 V, 52 V, or the like.

In a development of the invention, it is provided that the interface module comprises an electronic unit that translates a universal charging or final charging protocol transmitted via the at least one second universal interface into a charging or discharging protocol, in particular a proprietary protocol, which is necessary for the charging or discharging process of the electrochemical energy store connected to the first interface, and vice versa. With particular advantage, this allows the charging and discharging process to be started via the second universal interface. Otherwise, possible serious safety events could occur which can lead to considerable damage to the electrical consumer and/or the electrochemical energy store. The transfer of the protocols is preferably carried out via electrical data and signal contacts of the first and second interfaces.

The electronic unit checks, prior to the charging process of the electrochemical energy store, whether a DC voltage and/or a flowing DC current of the external constant-voltage or constant-current source applied to the at least one universal interface is greater than or equal to a maximum battery voltage and/or a maximum battery current for the electrochemical energy store. In this way, it can be ensured that the electrochemical energy store is not overloaded during the charging process, as the electronic unit only releases the charging process when the maximum limit values have not been exceeded. Accordingly, prior to the start of the discharging process via the at least one second universal interface, the electronic unit adjusts the battery voltage and/or the battery current as a function of a supply voltage and/or a supply current of the further electrical consumer connected to the at least one second universal interface in order to protect the connected electrical consumer from any damage. The corresponding limit values are determined analogously to the charging and/or discharging protocols via the corresponding electrical data or signal contacts of the first and second interfaces.

In addition the interface module comprises a DC/DC converter which is controlled by the electronics unit, such that the DC voltage applied to the at least one second universal interface and/or the flowing DC current is adapted to the battery voltage and/or the battery current of the electrochemical energy store, or in that the battery voltage and/or the battery current provided by the electrochemical energy store is adapted to the supply voltage and/or the supply current of the further electrical consumer connected to the at least one second universal interface. A control of the battery voltage or battery current is required to compensate for any deviations between the constant-voltage or constant-current source and the electrochemical energy store on the one hand and the electrochemical energy store and the further electrical consumer on the other.

It is further provided that the electronic unit monitors the charging and/or discharging process by means of at least one operating parameter measured in the interface module, in the electrochemical energy store, and/or in the electrical consumer. Preferably, the at least one operating parameter is configured as a measured actual voltage, a maximum battery voltage, a measured actual current, a current integral, a maximum battery current, an actual temperature, an upper and/or lower limit temperature, information about a coding resistance or other values for identifying the electrochemical energy store. If multiple operating parameters are used for monitoring, it is possible to use additional contacts of the interfaces designed as signal or data contacts. As mentioned at the beginning, all data signals can alternatively also be transferred via the electrical energy contacts of the interfaces in the sense of powerline communication. Corresponding methods for powerline communication are known to the skilled person and will not be further addressed herein.

In addition to the at least one second universal interface, further universal interfaces are provided for connection, in particular parallel connection, to corresponding universal counterpart interfaces of further constant-voltage or constant-current sources and/or further electrical consumers. This has the particular advantage of enabling charging with higher charging currents, for example for a fast charging function, as well as the simultaneous use of several different consumers, for example a light, a radio, a power bank, a smartphone, or the like. Furthermore, it may be provided that universal interfaces that are used for charging cannot be used for discharging and vice versa.

In order to prevent a voltage that may be hazardous to humans during a charging process being present at the unused universal interfaces or damage due to unforeseen short circuits, the electronic unit blocks these universal interfaces, in particular for the discharging process, if one or more of the universal interfaces are connected to an external constant-voltage or constant-current source.

With particular advantage, at least one of the universal interfaces is configured as a USB-C interface. In particular in conjunction with “USB-C next generation”, battery voltages of up to 48 V and charging currents of 4 to 5 A can then be achieved via the universal interface, which preferably causes correspondingly fast charging processes in high-performance energy stores, such as in some EPACs, e-bikes or e-scooters.

In addition or alternatively, at least one of the universal interfaces is designed as a CHAdeMO-EPAC interface with two power supply contacts, preferably three signal or data contacts. With particular advantage, high DC voltages and DC currents can be provided via the power supply contacts of the CHAdeMO-EPAC interface, while the signal and data contacts are used for transferring a plurality of the aforementioned operating parameters and the charging protocol in parallel.

Furthermore, it can be provided that at least one of the further, universal interfaces is configured as a wireless, in particular inductive, interface with at least one primary circuit for energy transfer, in particular according to the possibly further developed Qi or Ki standard or a protocol adapted for electric light vehicles on the WPP. The transfer of the charging or discharging protocol and/or operating parameters may then be performed via Near Field Communication (NFC) using a separate data circuit. As more and more smartphones can be loaded according to the Qi standard, this allows for very universal usability of the interface module.

For wireless data exchange with an external terminal device, such as a smartphone, a smart watch, a tablet, a PC, a remote cloud server, or the like, the interface module comprises a communication interface. In this way, the operating parameters can be monitored and settings can be made in the electronic unit with regard to different charging profiles, or the like. The communication interface preferably uses WLAN, Bluetooth, BLE, ZigBee, NFC, or the like for wireless transmission. A human machine interface (HMI) is also provided in the interface module for the local setting and/or display of the different charging profiles and/or the operating parameters. The HMI can, for example, be configured as a touch display, a display in connection with hardware buttons or as a simple LED display. Likewise, acoustic or haptic feedback is conceivable for certain settings.

Furthermore, the invention relates to an adapter with the interface module according to the invention, wherein the first interface of the interface module is configured as an electromechanical interface for the detachable connection without tools with a corresponding electromechanical interface of an electromechanical energy store or an electrical consumer, in particular an electric-motor-powered vehicle. The electromechanical interface may be configured as a cable connection with an electromechanical plug or as guide rails with electrical contacts received in a housing of the adapter. As the respective proprietary interfaces are configured very differently, this will not be discussed in further detail in the following. Like the first interface, the at least one second universal interface can also be configured as a cable connection or as a socket or plug integrated into the adapter. In addition, any mixed forms are contemplated. The adapter can be attached to a public charging infrastructure with particular advantage and can also be designed as a particularly compact travel charging adapter that can be carried in saddle bags, handbags, rucksacks, or the like. The term “releasable connection without tools” is understood in particular to mean a connection that can be released and established manually. As the person skilled in the art knows such electromechanical interfaces sufficiently in particular for exchangeable battery packs and thus operable electrical consumers, this should not be discussed in further detail.

The invention also relates to an electric-motor-powered vehicle having the interface module according to the invention, wherein the interface module is fixedly integrated into a frame or housing part of the electric-motor-powered vehicle, in particular a drive unit of the electric-motor-powered vehicle.

### EXEMPLARY EMBODIMENTS

### Drawings

The invention is explained below with reference to FIGS. 1 through 6 by way of example, wherein identical reference numbers in the drawings indicate identical components having an identical function.

Shown are:

FIG. 1: a block diagram of a system consisting of a charger, an electrochemical energy store and the interface module according to the invention in a first exemplary embodiment,

FIG. 2: a further schematic representation of an interface module according to the invention in a further embodiment,

FIG. 3: a schematic representation of a system consisting of an electrical consumer configured as an electric bicycle with an electrochemical energy store unit configured as an exchangeable battery pack and the interface module according to the invention in a third exemplary embodiment,

FIG. 4: a perspective view of the energy store configured as an exchangeable battery pack without (FIG. 4a) and with (FIG. 4b) the interface module configured as an adapter according to the invention in a fourth embodiment,

FIG. 5: a perspective view of the electric consumer configured as an electric bicycle with a fixedly integrated interface module according to the invention in a fifth embodiment; and

FIG. 6: a perspective view of the electrochemical energy store configured as an exchangeable battery pack with a fixedly integrated interface module according to the invention in a sixth embodiment.

### DESCRIPTION OF THE EXEMPLARY EMBODIMENTS

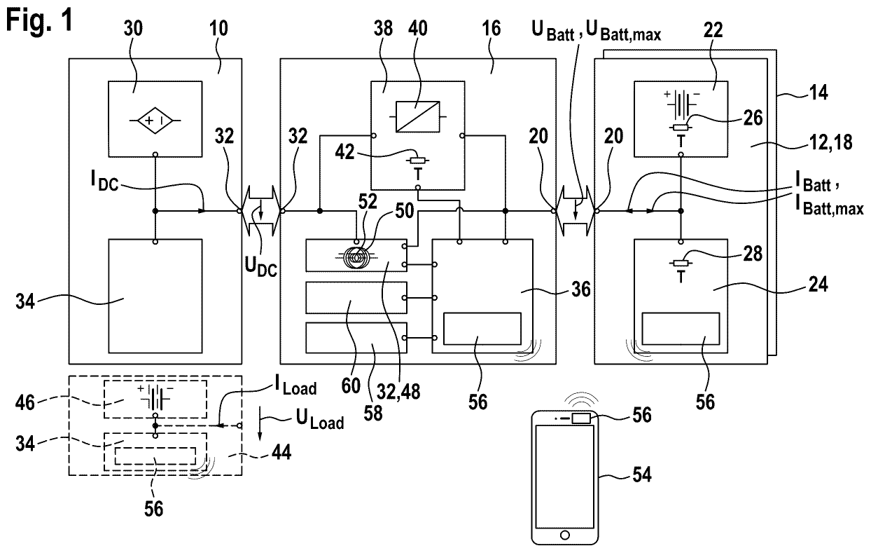

FIG. 1 shows a block diagram of a system consisting of a commercially available charger 10, a commercially available rechargeable electrochemical energy store 12 for an electrical consumer 14 and the interface module 16 according to the invention in a first exemplary embodiment. The electrochemical energy store 12 can be both fixedly integrated in the electrical consumer 14 and can be configured as an exchangeable battery pack 18 which can be connected to the electrical consumer 14. Preferably, the exchangeable battery pack 18 is releasably connected to the electrical consumer 14 via a first electromechanical interface 20 and a corresponding counterpart, i.e., by hand. For this purpose, the first electromechanical interface 20 has, in addition to the electrical contacts for the power supply and for the data or signal transmission (not shown in more detail), possible mechanical coding, for example in the form of special slide rails, contact arrangements, recesses, projections, etc., which allow a connection only in conjunction with the corresponding mechanical coding of the counter-interface. As these mechanical codings are often manufacturer-specific, the first interfaces 20 are proprietary. However, a proprietary interface 20 is also intended to be used, in contrast to a universal interface, only by a restricted circle, for example a group of manufacturers or a battery alliance. In this context, a universal interface is to be understood to be freely usable across manufacturers. As the proprietary interfaces can therefore be designed very differently, their configuration will not be discussed in more detail below. Depending on the application and manufacturer, a person skilled in the art will therefore use the corresponding proprietary first interface 20. Alternatively, for reasons of theft protection or other safety measures, it may be useful for the exchangeable battery pack 18 to be removed from the electrical consumer 14 only with the aid of special tools or by means of a mechanical key. It may also be provided that the exchangeable battery pack 18 is electronically secured in the electrical consumer 14.

The electrochemical energy store 12 comprises a plurality of energy store cells 22, which may be connected in a series circuit and/or in a parallel circuit, wherein the series circuit defines a battery voltage U_{Batt} of the electrochemical energy store 12 dropping across the power supply contacts of the first electromechanical interface 20, while the parallel circuit of individual energy store cells 22 primarily increases the capacity of the electrochemical energy store 12. Individual cell clusters of energy store cells 22 connected in parallel can also be connected in series, in order to achieve a specific voltage U_{Batt} with simultaneously increased capacity. In common Li-ion round storage cells 22 having a nominal cell voltage U_{Cell} of 3.6 V each, battery voltages U_{Batt} of n 3.6 V drop across the energy supply contacts of the first interface 22, where n defines the number of energy storage cells 22 or cell clusters connected in series. For other electrochemical energy storage cells 22, the nominal cell voltage U_{Cell} may deviate, so that battery voltages of 3.6 V to 70 V and more are possible depending on the type and application case of the electrochemical energy store 12. Depending on the number of energy storage cells 22 connected in parallel in a cell cluster, the capacity of commercially available high-performance energy stores 12 can be up to 14 Ah and more, such that, for example, up to 750 Wh can be achieved in the e-bike range. However, the invention is not dependent on the type, design, voltage, power supply capability, etc. of the energy storage cells 22 used, but can be used for a plurality of different energy stores 12.

For monitoring the individual energy storage cells 22 or cell clusters of the energy store 12 connected in series, an SCM (single cell monitoring) precursor (not shown), which is controlled by an electronic unit 24 of the energy store 12 may be provided. The electronic unit 24 may be configured as an integrated circuit in the form of a microprocessor, ASIC, DSP or the like. However, it is also conceivable that the electronic unit 24 consists of multiple microprocessors or at least partly of discrete components with corresponding transistor logic. In addition, the electronic unit 24 may comprise a storage system for storing operating parameters of the energy sore 12, such as the battery voltage U_{Batt}, the cell voltages U_{Cell}, a temperature T, a battery current I, or the like. By means of a temperature sensor 26 arranged in the electrochemical energy store 12, preferably designed as an NTC and in close thermal contact with at least one of the energy store cells 22, a temperature T of the energy store 12 or the energy storage cells 22 can be measured. In order for a charger (not shown) connected to the first interface 20, to identify the energy store 12 and, if necessary, release it for charging, the energy store 12 has a coding resistance 28 with a fixed resistance value R_{C}. If the resistance value R_{C} of the coding resistor 28 configured as a further operating parameter matches a value stored in the charger, the charger releases the charging process and charges the energy store 12 according to the operating parameters stored in a look-up table, in particular the measured battery current I, a maximum battery current I_{Batt,max}, the measured battery voltage U_{Batt}, a maximum battery voltage U_{Batt,max}, the measured temperature T, an allowable temperature range, etc. In the same way, the electrical consumer 14 can release the discharging process of the energy store 12 via the coding resistor 28 or a further coding resistance (not shown). If the values do not match, the discharging process of the energy store 12 is stopped or not allowed, so that the electrical consumer 14 cannot be put into operation. If the values match, an operator can put the electrical consumer 14 into operation. Furthermore, corresponding charging or discharging protocols can also be transferred via the first interface 20 for identification or adjustment of the operating parameters.

Typically, a charger connectable to the first interface 20 is used to charge the energy store 12. However, such chargers often need to be adapted or flexibly adaptable to the specifications of the energy store 12 to be charged with them. In addition to AC/DC conversion, this often also requires expensive isolation transformers as well as power, rectifier and filter stages. In this respect, the interface module 16 according to the invention now offers the advantage that a particularly simple and cost-efficient charger 10 can be used for universal charging of the energy store 12. The charger 10 has a constant-voltage or constant-current source 30 or is configured as such, so that the AC/DC conversion, any isolating transformers and any cost-intensive power, rectification and filter stages can be omitted. Such universal chargers 10 or constant-voltage or constant-current sources 30 are sufficiently well known as plug-in power supplies, or the like, and are commercially available so that they will not to be discussed further here. They typically have a universal interface 32 in the form of a USB port (e.g., USB-A, USB-C) or the like, via whose electrical contacts not only the energy but also a specific charging protocol (PD—Power Delivery) for a connected electrical consumer or its energy store can be transferred and evaluated in an electronic unit 34 integrated in the charger 10.

The interface module 16 according to the invention is now intended to make such a universal charger 10 usable for charging the electrochemical energy store 12. For this purpose, it comprises a first interface 20 for electrical connection to the corresponding proprietary counterpart interface 20 of the electrochemical energy store 12. On the other hand, at least a second universal interface 32 is provided that is electrically connected to the first interface 20, such that an external constant-voltage or constant-current source 30 connected to the at least one second universal interface 32 can charge the energy store 20.

The interface module 16 also comprises an electronic unit 36 that translates a universal charging or final charging protocol transmitted via the at least one second universal interface 32 into a charging or discharging protocol, in particular a proprietary protocol, which is necessary for the charging or discharging process of the electrochemical energy store 12 connected to the first interface 20, and vice versa. This is necessary to prevent any serious safety events that could result in significant damage to the electrical consumer 14 and/or the energy store 12. For this purpose, the electronic unit 36 controls the power electronics 38 of the interface module 16 in order to be able to interrupt the charging or discharging process by means of corresponding switching means (e.g., relays, transistors) in the event of deviations or discrepancies. Moreover, the power electronics 38 may comprise further filter means for a possibly necessary improvement of the electromagnetic compatibility (EMC) of the interface module 16. It may also be provided that the electronic unit 36 checks, prior to the charging process of the electrochemical energy store 12, whether a DC voltage U_{DC} and/or a flowing DC current I_{DC} of the external constant-voltage or constant-current source 30 applied to the at least one second universal interface 32 is greater than or equal to a maximum battery voltage U_{Batt,max} and/or a maximum battery current I_{Batt,max} for the energy store 12. In this way, it can be ensured that the energy store 12 is not overloaded during the charging process, as the electronic unit 36 only releases the charging process when the maximum limit values have not been exceeded.

A DC/DC converter 40 of the power electronics 38 is also used for any necessary adjustment between the DC voltage U_{DC} or the flowing DC current I_{DC} provided by the constant-voltage or constant-current source 30 and the battery voltage U_{Batt} or the battery current I_{Batt} required for charging the energy store 12 or the maximum battery voltage U_{Batt,max}, or the maximum battery current I_{Batt}, permitted to charge the energy store 12 The control is required or advantageous because the external constant-voltage or constant-current source 30 can only provide a constant DC voltage U_{DC} or a constant DC current I_{DC} and these are not always suitable for charging the energy store 12. In addition, the power electronics 38 may comprise a temperature sensor 42 for sensing the temperature T occurring in the interface module 16 or in the power electronics 38, such that the electronic unit 36 may interrupt or reduce the charging process if the temperature values are too high. Accordingly, the electronic unit 36 may receive the operating parameters stored in the energy store 12 and in the electronic unit 24 therein via the first interface 20 and store and evaluate them to regulate the charging process.

The first and the at least one second universal interfaces 20, 32 may be used not only for charging but also for discharging the energy store 12. This means that not only the data or signal transmission via the first and second interfaces 20, 32 bidirectional, but also the energy transport. For this reason, the arrows between interfaces 20, 32 were also shown as double arrows. If, instead of the charger 10, a further electrical consumer 44 is connected with its universal interface 32 to the at least one second universal interface 32 of the interface module 16, the electronic unit 36 of the interface module 16, prior to the start of the discharging process of the energy store 12, adjusts the battery voltage U_{Batt} and/or the battery current I_{Batt} by means of the DC/DC converter 40 as a function of a supply voltage U_{Load} and/or a supply current I_{Load} of the further electrical consumer 44, in particular, an energy store 46 integrated in the further electrical consumer, in order to protect the connected electrical consumer from possible damage. Accordingly, any protective measures that may be implemented for the charging process by means of the power electronics 38 are also possible for the discharging process.

Optionally, the interface module 16 may have an additional universal interface 32 configured as a wireless, in particular inductive, interface 48 having at least one primary circuit 50 for energy transfer, in particular according to the Qi standard, Ki standard, or a further developed protocol on the basis thereof. The transfer of the charging or discharging protocol and operating parameters may then be performed via Near Field Communication (NFC) using a separate data circuit 52, which is preferably arranged concentrically within the primary circuit 50. In this way, for example, the energy store 46 of a further electrical consumer 44 configured as a smartphone can be inductively charged via the interface module 16.

For wireless data exchange with an external terminal device 54, such as a smartphone, a smart watch, a tablet, a PC, a remote cloud server, or the like, the interface module 16b and the external terminal device 54 each comprise a communication interface 56. In this way, the operating parameters can be monitored via the app and settings can be made in the electronic unit 36 with regard to different charging profiles, time-controlled charging or discharging, a winter/transport/storage mode (discharging the energy store 12 to 50%/30%), or the like. The communication interface 56 preferably uses WLAN, Bluetooth, BLE, ZigBee, NFC, or the like for wireless transmission. Corresponding communication interfaces 56 may also be provided in the energy store 12, in the electrical consumer 14, and/or in the further electrical consumer 44.

A human machine interface (HMI) 58 is also provided in the interface module 16 to locally adjust and/or display the different charging profiles, operating parameters, and/or state of charge of the energy store 12. The HMI 58 can, for example, be configured as a touch display, a display in connection with hardware buttons or as a simple LED display. Likewise, acoustic or haptic feedback is conceivable for certain settings.

Furthermore, the interface module may have additional functions 60, for example in the form of a flashlight, an integrated radio, a local weather station (measurement of ambient temperature, humidity, brightness, etc.), a data hub, or the like.

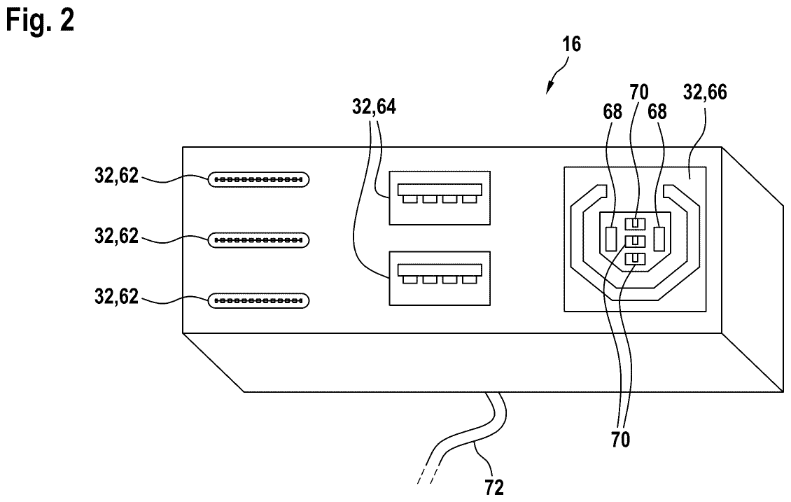

FIG. 2 shows the interface module in a further embodiment. It has a plurality of a total of six universal interfaces 32 for in particular parallel connection with corresponding universal counterpart interfaces of further constant-voltage or constant-current sources 30 and/or further electrical consumers 44. This has the particular advantage of enabling charging with a higher battery current I_{Batt}, for example for a fast charging function, as well as the simultaneous use of several different consumers 44, for example a light, a radio, a power bank, a smartphone, or the like.

In order to prevent a voltage that may be hazardous to humans during a charging process being present at the unused universal interfaces 32 or damage due to unforeseen short circuits, the electronic unit b36 locks these universal interfaces by the power electronics 38, in particular for the discharging process, if one or more of the universal interfaces 32 are connected to an external constant-voltage or constant-current source 30.

Three of the six universal interfaces 32 are each configured as a USB-C interface 62. In particular in conjunction with “USB-C next generation”, a battery voltage U_{Batt} of up to 48 V and a battery current I_{Batt} of 4 to 5 A can be provided in this way via the universal interface 32, which preferably enables correspondingly fast charging processes for an electrochemical energy store 32 designed as a high-performance energy store, such as is used in some EPACs or e-bikes. USB-C interfaces 62 may be used for both charging and discharging of energy store 12 connected to the first interface 20 via a cable 72.

Two further universal interfaces 32 of the interface module 16 are configured as a USB-A interface 64. As only limited electrical power is transferable via such a universal interface 32, USB-A interfaces 64 are preferably only used for discharging the energy store 32 and/or for data transfer for corresponding electrical consumers 44. It is possible, for example, for the interface module 16 to serve as a data hub for USB-C interfaces 62 and USB-A interfaces 64.

In order to also enable charging via public charging points, one of the universal interfaces 32 is configured as a CHAdeMO-EPAC interface 66 with two power supply contacts 68 and preferably three signal or data contacts 70. With particular advantage, high DC voltages U_{DC} and DC currents I_{DC} can be provided via the power supply contacts 68 of the CHAdeMO-EPAC interface 66, while the signal and data contacts 70 are used for transferring a plurality of the aforementioned operating parameters and the charging protocol in parallel. In addition to the universal interfaces 32 shown, other types of universal interfaces 32 are contemplated for energy and/or data transfer in the interface module 16.

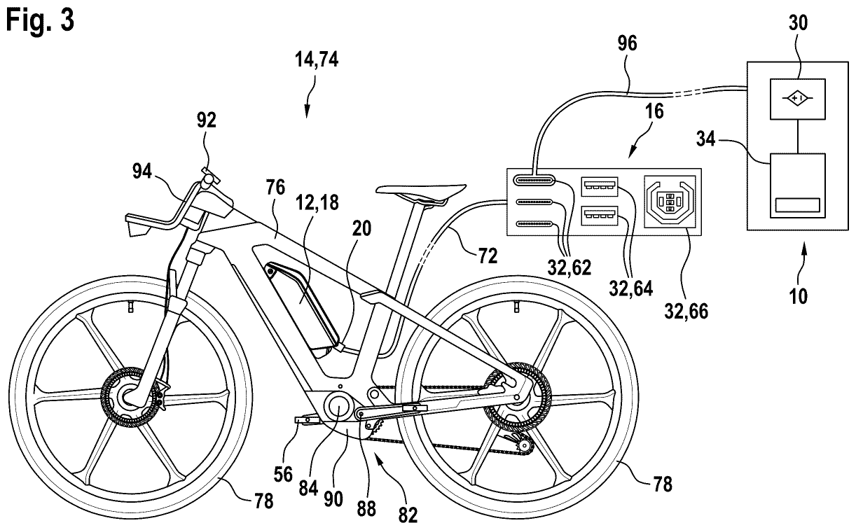

FIG. 3 shows a schematic representation of a system that consists of the electrical consumer 14 configured as an electric bicycle 74 with the electromechanical energy store 12 configured as an exchangeable battery pack 18, the charger 10 with the constant-voltage or constant-current source 30 and the interface module 16 according to the invention. The electric bicycle 74 can, e.g., be designed as a pedelec, an e-bike, or the like.

The electric bicycle 74 has a housing in the form of a frame 76 with two wheels 78 supported in the frame 76. The exchangeable battery pack 18 is also releasably connected to the frame 76 via a connection device 80. The electric bicycle 74 also comprises a drive unit 82, which comprises an electric motor 84, preferably in the form of an EC or BLDC motor, in the form of a center motor. Alternatively, a hub motor may also be used in one of the wheels 78 instead of a center motor. The electric bicycle 74, in particular its drive unit 82, is powered via the exchangeable battery pack 18. The drive unit 82 comprises an electronic unit (not shown) to control or regulate the electric bicycle 74, in particular the electric motor 84. The electronic unit is further connected to a sensor unit (not shown), which comprises, e.g., multiple sensor elements, such as a torque sensor, a motion sensor, e.g., in the form of an acceleration sensor, and a magnetic sensor. The electric bicycle 74 further includes a pedal crank 86 having a pedal crankshaft 88. The electronic unit, the drive unit 82 having the electric motor 84 and the pedal crankshaft 88 are arranged within a drive housing 90 connected to the frame 76.

The drive movement of the electric motor 84 is preferably transmitted to the pedal crankshaft 88 via a transmission (not shown), wherein the intensity of the assistance by the drive unit 82 is controlled or regulated via the electronic unit. The electronic unit is designed to control the drive unit 82 such that the rider of the electric bicycle 74 is assisted in pedaling. Preferably, the electronic unit is designed such that it can be operated by the rider so that the rider can set the assistance level.

The electric bicycle 74 also comprises, e.g., an on-board computer 92 arranged on a handlebar 94 of the electric bicycle 74. The on-board computer 92 is, by way of example, designed to be in part detachable from the electric bicycle 74. The on-board computer 92 includes an HMI that is used to display information and control the on-board computer 92 and/or the electric bicycle 74 and the drive unit 82. The HMI is exemplary configured as a touch screen or the like. The on-board computer 92 is connected to the drive unit 82 for exchanging information and commands. For example, the HMI can be used to display a speed determined by the electronic unit of the drive unit 82, a set level of assistance of the electric motor 84, route information from a navigation unit integrated in the on-board computer 92 or a charge status of the exchangeable battery pack 18.

According to the description for FIGS. 1 and 2, the exchangeable battery pack 18 can now be charged by the constant-voltage or constant-current source 30 of the charger 10 and the interface module 16 according to the invention. For this purpose, the interface module 16 is connected to the charger 10 via at least one of the universal interfaces 32, for example by means of a suitable USB-C cable 96, and via the first proprietary interface 20 and the cable 72 fixedly connected to the interface unit 16.

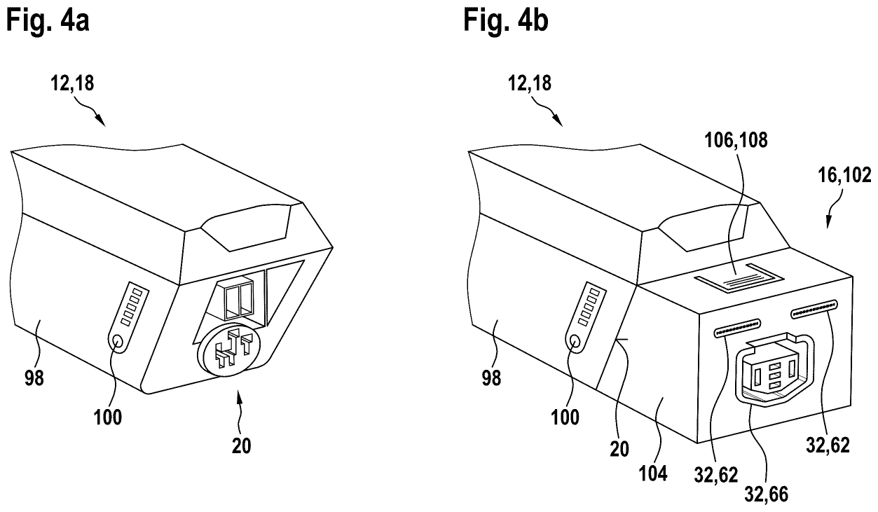

In FIG. 4, the electromechanical energy store 12 configured as the exchangeable battery pack 18 for the electrical consumer 14 configured as the electric bicycle 74 is shown in a partial perspective view. The exchangeable battery pack 18 comprises a housing 98, which is formed by way of example from a plurality of housing parts. A plurality of energy store cells 22 (not shown) is arranged in the housing 98 by at least one cell holder (not shown). In addition, the electronic unit 24 described in FIG. 1 for the battery management system (BMS) and optionally at least one of the temperature sensors 26, 28 and the communication interface 56 is included in the housing 98 of the exchangeable battery pack 18. An HMI 100 is provided on a first outer side of the housing 98 as a charge state and error indicator. According to FIG. 4a, the proprietary electromechanical interface 20 is located on a further outer side of the housing 98, via whose electrical contacts the exchange battery pack 18 can be charged with a special charger on the one hand and discharged by the electric wheel 74 on the other. For this purpose, the specific charger and the electric bicycle 74 each have corresponding counterpart interfaces 20. In addition, further electrical contacts of the proprietary electromechanical interfaces 20 are provided as data and signal contacts for transmitting the operating parameters and the corresponding charging or discharging protocols. The electrical contact can, e.g., be designed as spring contact elements in the form of contact tulips or as flat contacts in the form of contact blades.

FIG. 4b shows the interface module 16 attached to the proprietary interface 20 in the configuration of an adapter 102 with a stand-alone housing 104. The housing 104 can be formed in one or more parts and surrounds all electronic components of the interface module 16 (see FIG. 1) completely to protect it from moisture and dirt. Preferably, the housing 104 is made of plastic. However, other materials, such as metal, wood, ceramic composites, or the like, are contemplated. On a first outer side of the housing 104, the proprietary interface 20 (not visible) is provided for releasable connection to the proprietary interface 20 of the interchangeable battery pack 18 without tools. To fix the adapter 102 to the exchangeable battery pack 18, a locking device 106 is provided that engages with corresponding fixation elements of the proprietary interface 20 of the exchangeable battery pack 18 when the adapter 102 is attached. In order to be able to loosen the adapter 102 without tools, an actuating button 108 is provided on a further outer side of the adapter 102, which releases the locking device 106 when actuated accordingly, so that the adapter 102 can be withdrawn from the proprietary interface 20 of the exchangeable battery pack 18.

On at least a third outer side of the housing 104, the universal interfaces 32 are arranged such that they are freely accessible with the adapter 102 attached to the exchangeable battery pack 18. By way of example, two universal USB-C interfaces 62 and one universal CHAdeMO-EPAC interface 66 are provided. The adapter may be connected to a public charging infrastructure with particular advantage via the CHAdeMO-EPAC interface 66. Alternatively, charging via USB-C interfaces 62 is also possible. They can also be used to discharge the exchangeable battery pack 18 in the sense of a power bank for further electrical consumers 44 (see FIG. 1). The adapter 102 can be particularly compact as a travel adapter, for example to be carried in saddle bags, handbags, rucksacks or the like.

Furthermore, the adapter 102 may also be configured to be directly connectable via the proprietary interface 20 to a corresponding counterpart interface 20 of the electric bicycle 74 to supply it. This is particularly advantageous if the electric bicycle 74 comprises a fixed-mounted electrochemical energy store 12.

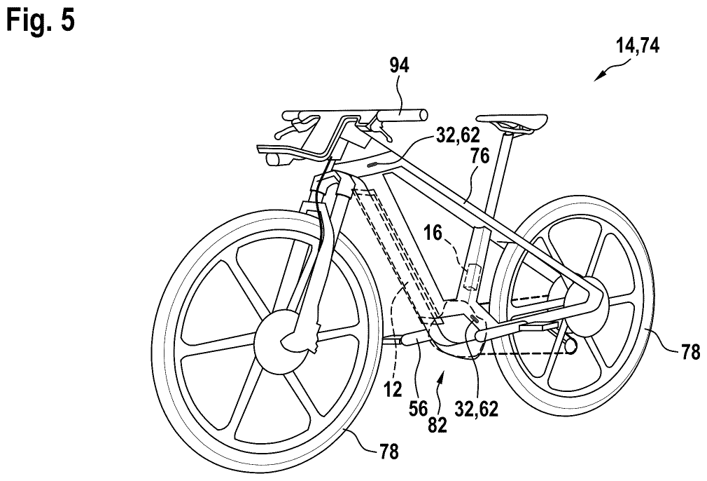

FIG. 5 shows such an electric bicycle 74 with a fixed mounted electrochemical energy store 12. Unlike the previous exemplary embodiments, the interface module 16 is now fully integrated within the frame 76 of the electric bicycle 74. For charging and discharging the energy store 12 via the interface module 16, the electric cycle 74 now directly comprises two universal interfaces 32. These are configured as USB-C interfaces 62, by way of example, wherein a first USB-C interface 62 is arranged within the frame 76 of the electric bicycle 74 and a second USB-C interface is arranged within the drive housing 90 of the drive unit 82. As both the energy store 12 and the interface module 16 are fixedly integrated within the frame 76 of the electric bicycle 74, the proprietary interfaces 20 may be omitted. Instead, energy store 12 and interface module 16 may be hardwired together. Nonetheless, the term “interface module” is also to be used here because a corresponding translation of the charging and discharging protocols for the universal interfaces 32 is still required. The functionality of the interface module 16 according to FIG. 5 does not differ in any other way from the embodiments of the interface module 16 described in FIGS. 1 to 4.

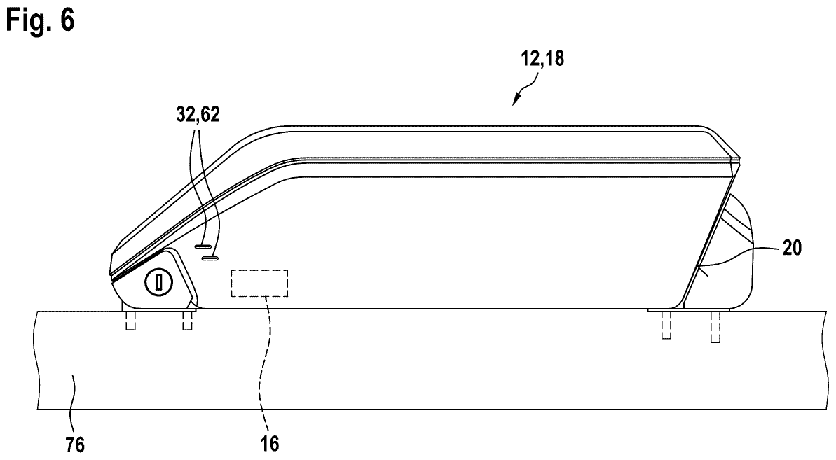

In FIG. 6, a further embodiment of the interface module 16 according to the invention is shown. In this case, it is directly integrated in the exchangeable battery pack 18. In addition to the proprietary interface 20, the exchangeable battery pack 18 now has, for example, two universal interfaces 32 in the form of USB-C ports 62. Thus, the exchangeable battery pack 18 can be charged directly via the universal interfaces 32 using a suitable constant-voltage or constant-current source 30 or, when removed, via the proprietary interface 20 using a suitable charger. In contrast to the proprietary interface 20, the universal interfaces 32 therefore also allow charging when connected to the frame 76 of the electric bicycle 74. In addition, the universal interfaces 32 for discharging the exchangeable battery pack 18 in terms of a power bank for at least one further electrical consumer 44 can be used.

Finally, it should be pointed out that the exemplary embodiments shown are not limited to FIGS. 1 through 6 or to the values and size proportions shown. In particular, the universal interfaces 32 were not presented to scale for ease of recognition.

1. An interface module for charging and discharging an electrochemical energy store for an electrical consumer, the interface module comprising:
a first interface configured to connect to a corresponding counterpart interface of the electrochemical energy store; and
at least one second interface electrically connected to the first interface, and
wherein the at least one second interface is of universal design such that the interface module is configured to connect to:
a corresponding counterpart interface of an external constant-voltage or constant-current source during a charging process of the electrochemical energy store, and
a corresponding counterpart interface of a further electrical consumer during a discharging process of the electrochemical energy store.

2. The interface module according to claim 1, further comprising:
an electronic unit that translates a universal charging or final charging protocol transmitted via the at least one second interface into a charging or discharging protocol, which is configured for the charging or discharging process of the electrochemical energy store connected to the first interface, and vice versa.

3. The interface module according to claim 2, wherein the electronic unit is configured to check, prior to the charging process of the electrochemical energy store, whether a DC voltage applied to the at least one second interface and/or a flowing DC current of the external constant-voltage or constant-current source is greater than or equal to a maximum battery voltage and/or a maximum battery current for the electrochemical energy store.

4. The interface module according to claim 3, wherein the electronic unit is configured to set a battery voltage and/or a battery current for discharging the electrochemical energy store via the at least one second interface as a function of a supply voltage and/or a supply current of the further electrical consumer connected to the at least one second interface.

5. The interface module according to claim 4, wherein:
the interface module comprises a DC/DC converter which is controlled by the electronic unit such that the DC voltage applied to the at least one second universal interface and/or the flowing DC current is adapted to the battery voltage and/or the battery current of the electrochemical energy store, or
the battery voltage and/or the battery current provided by the electrochemical energy store is adapted to the supply voltage and/or the supply current of the further electrical consumer connected to the at least one second interface.

6. The interface module according to claim 2, wherein the electronic unit is further configured to monitor the charging and/or discharging process via at least one operating parameter measured in the interface module, in the electrochemical energy store, and/or in the electrical consumer.

7. The interface module according to claim 2, further comprising:
further universal interfaces configured for parallel connection to corresponding universal counterpart interfaces of further constant-voltage or constant-current sources and/or further electrical consumers.

8. The interface module according to claim 7, wherein the electronic unit is configured to block all unused universal interfaces of the at least one second interface and the further universal interfaces for the discharging process when at least one interface of the at least one second interface or the further universal interfaces is connected to an external constant-voltage or constant-current source.

9. The interface module according to claim 1, wherein at least one interface of the at least one second interface is configured as a USB-C interface.

10. The interface module according to claim 1, wherein at least one interface of the at least one second interface is configured as a CHAdeMO-EPAC interface with two energy supply contacts and three signal or data contacts.

11. The interface module according to claim 7, wherein at least one of the further universal interfaces is configured as a wireless inductive interface with at least one primary circuit for energy transfer according to a Qi or Ki standard.

12. The interface module according to claim 11, wherein the transfer of the charging or discharging protocol and/or operating parameters is carried out via the wireless inductive interface via Near Field Communication using a separate data circuit.

13. The interface module according to claim 1, further comprising:
a communication interface configured for wirelessly exchanging signals or data with an external terminal device.

14. The interface module according to claim 2, further comprising:
a human machine interface configured for adjusting and/or displaying operating parameters and/or different charging profiles of the electronic unit.

15. An adapter comprising:
an interface module according to claim 1,
wherein the first interface of the interface module is configured as an electromechanical interface for tool-free detachable connection to a corresponding electromechanical interface of an electrochemical energy store or an electrical consumer.

16. An electric-motor-powered vehicle comprising:
an interface module according to claim 1; and
a frame or housing part into which the interface module is fixedly integrated.

17. The interface module according to claim 1, wherein the first interface is configured as a proprietary design.

18. The electric-motor-powered vehicle according to claim 16, wherein the frame or housing part into which the interface module is fixedly integrated is a drive unit of the electric-motor-powered vehicle.
